(19) United States
(12) Patent Application Publication
(10) Pub. No.: US 2008/0238806 A1
(43) Pub. Date: Oct. 2, 2008

(54) ANTENNA STRUCTURE OF MOBILE PHONE

(75) Inventors: Chao-Hui Yu, Taipei Hsien (TW); Hung-Jen Chen, Taipei Hsien (TW); Jia-Hung Su, Taipei Hsien (TW); Kai Shih, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/691,026

(22) Filed: Mar. 26, 2007

(51) Int. Cl. H01Q 9/04; H01Q 1/12

(52) U.S. Cl. 343/872; 343/700 MS

(57) ABSTRACT

An antenna structure for mobile phone comprises a PCB (printed circuit board), an antenna portion and a second grounding portion position connected to the PCB. A face of the PCB is smeared with a stratum metal material and functioning as a first grounding portion. The antenna portion further has an antenna, a feeding point and a grounding point connected with the antenna. The second grounding portion connected to the PCB on another side of the PCB opposite to the antenna portion. Because the area of the grounding portion is increased, the electric field could be equality distributed within the whole grounding portion.

### BACKGROUND OF THE INVENTION

1. Field of the Invention

The present invention relates to an antenna structure of mobile phone, and particularly to an antenna structure with lower specific absorption rate (SAR).

2. The Related Art

As the development of modern mobile communication industry, mobile phone becomes popular. However, the electromagnetic wave sent from the mobile phones might be harmful to the health of the user. The user of the mobile phone must make the head approached to the mobile phone. At the same time, the electromagnetic wave goes through the head. Consequently, part of the electromagnetic wave is absorbed by the body and further changed into heat energy which might be harmful to the user. Therefore, modern mobile phones are required to lower the SAR(Specific Absorption Rate) which is the measurement for determining the amount of RF energy absorbed by the body when using a mobile phone. It is benefit for user's healthy.

As shown in FIG. 2, a conventional antenna structure 1 includes an antenna portion 60 positioned in the front end of a mobile phone and a metal grounding portion 70 connected to the antenna portion 60. The antenna portion 60 further includes a printed circuit board (PCB) 61 and an antenna 62 printed on the PCB 61. The antenna 62 has a feeding point 63 and a grounding point 64 which is connected with the metal grounding portion 70. Generally, the metal grounding portion 70 has an oblong shape for matching up the shape of the mobile phone.

However, the area of the oblong-shape grounding portion 70 described in above is restricted by the shape of the mobile phone, as a result, the magnetic filed is unequality distributed on the antenna 62 and leads to a high SAR.

### SUMMARY OF THE INVENTION

Accordingly, an object of the present invention is to provide an antenna structure with improved mechanism to reduce the SAR value. The antenna structure is inside of the mobile phone. The antenna structure includes an antenna portion, a metal second grounding portion, and a PCB connected to the antenna portion. One face of the PCB is smeared with stratum metal material, thereby it functions as a first grounding portion. The antenna portion is connected to the top of the PCB. On another hand, the second grounding portion is connected to the top of the PCB on another side of the PCB opposite to the antenna portion. The PCB is position between the antenna portion and a second grounding portion. As described above, the second grounding portion is the extra installation positioned on the PCB of the antenna structure. Because the area of the grounding portion is increased, the electric field could be equality distributed within the whole grounding portion. Therefore, the SAR could be reduced without any change to the shape of the mobile phone and maintaining the gain of the antenna.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an antenna structure according to the present invention; and

FIG. 2 is a perspective view of a conventional antenna structure according to the present invention.

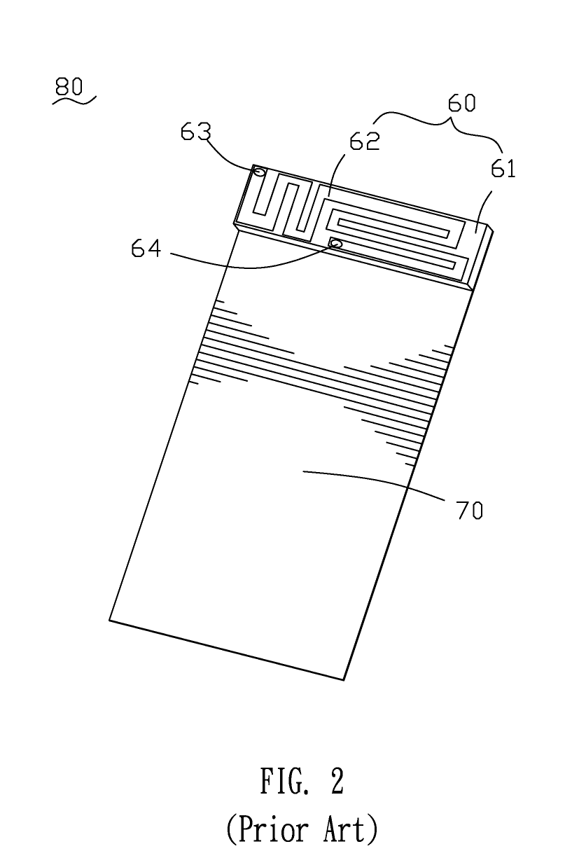

### DETAILED DESCRIPTION OF THE PREFERRED EMBODIMENTS

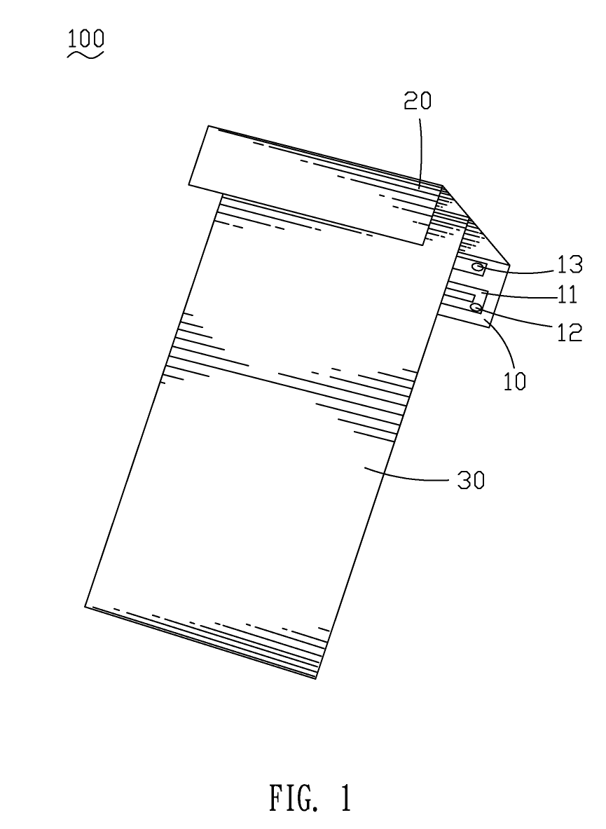

The antenna structure 100 according to a preferred embodiment of the present invention is illustrated in FIG. 1 and provides a new structure to reduce SAR of the antenna.

Referring now to FIG. 1, the antenna structure 100 includes an antenna portion 10, a metal second grounding portion 20, and a PCB 30 connected to the antenna portion 10. One face (or two faces) of the PCB 30 is smeared with stratum metal material, thereby it functions as a first grounding portion. The antenna portion 10 is connected to the top of the PCB 30, on another hand, the second grounding portion 20 is connected to the top of the PCB 30 on another side of the PCB 30 opposite to the antenna portion 10. Particularly, the second grounding portion has a folded portion which is spaced from the PCB 30. The PCB 30 is positioned between the antenna portion 10 and a second grounding portion 20.

The antenna portion 10 includes an antenna 11, a feeding point 12 and a grounding point 13 connected to the antenna 11. The grounding point 13 electrically connects with the PCB 30. In this embodiment of the antenna portion 10, the antenna 11 is a hided-type antenna which is designed to be fixed inside the mobile phone. However, the antenna 11 is not only limited to a hided-type antenna, but also may be other types such as exposed-type antenna which is fixed exposed outside the mobile phone. Also, the antenna 11 can be printed on the PCB 30 directly.

The second grounding portion 20 has a sheet metal shape and extends from the top of the PCB 30. Further more, the second grounding portion 20 can be bent to match the shape of the mobile phone.

As described above, the second grounding portion is the extra installation positioned on the PCB 30 of the antenna structure 100. Because the area of the grounding portion is increased, the electric field could be equality distributed within the whole grounding portion. Therefore, the SAR could be reduced without any change to the shape of the mobile phone and maintaining the gain of the antenna.

What is claimed is:

1. An antenna structure for mobile phone, comprising:
a printed circuit board, a face of the printed circuit board smeared with a tier of metal material as a first grounding portion;
an antenna, defined at an antenna portion connected with the printed circuit board, a feeding point and a grounding point connected with the antenna, the grounding point further connected with the printed circuit board; and
a second grounding position, opposite to the antenna portion, connected to the printed circuit board, which is in a sheet metal shape and extends from the top of the printed circuit board, further having a folded portion spaced from the printed circuit board, wherein the printed circuit board is positioned between the second grounding portion and the antenna portion.

2. The antenna structure as claimed in claim 1, wherein the antenna is printed on the printed circuit board.

3. The antenna structure as claimed in claim 1, wherein said antenna structure is fixed inside the mobile phone.
